(19) United States
(12) Patent Application Publication
(10) Pub. No.: US 2025/0353764 A1
(43) Pub. Date: Nov. 20, 2025

(54) WATER TREATMENT DEVICE AND WATER TREATMENT METHOD

(71) Applicant: ORGANO CORPORATION, Tokyo (JP)

(72) Inventor: Hironori YUI, Tokyo (JP)

(73) Assignee: ORGANO CORPORATION, Tokyo (JP)

(21) Appl. No.: 18/996,189

(22) PCT Filed: May 2, 2023
(86) PCT No.: PCT/JP2023/017115

§ 371 Date: Jan. 17, 2025

(30) Foreign Application Priority Data
Jul. 27, 2022 (JP) 2022-119502

(51) Int. Cl. C02F 3/12; C02F 1/00; C02F 3/34; C02F 9/00; C02F 101/16

(52) U.S. Cl. CPC C02F 3/121; C02F 3/34; C02F 9/00; C02F 1/004; C02F 2101/16; C02F 2209/14; C02F 2209/40; C02F 2301/043; C02F 2301/08

(57) ABSTRACT

This water treatment device is characterized by having: a first biological treatment tank in which water being treated that contains ammonia nitrogen is biologically treated while being continuously channeled in; a second biological treatment tank in which first treatment water that is obtained through treatment in the first biological treatment tank is biologically treated while being continuously channeled in; a bypass line that bypass-channels some of the water being treated to the second biological treatment tank so as to bypass the first biological treatment tank; an ammonia nitrogen concentration meter that measures the concentration of ammonia nitrogen in second treatment water that is obtained through treatment in the second biological treatment tank; and a control unit that controls the channel amount of water being treated that flows through the bypass pipeline on the basis of the ammonia nitrogen concentration measured by the ammonia nitrogen concentration meter.

### TECHNICAL FIELD

The present invention relates to a water treatment device and a water treatment method for treating a water to be treated containing ammonia nitrogen.

### BACKGROUND

Conventionally, because ammonia and nitric acid and the like are used in semiconductor production processes for integrated circuits (IC) and the like, wastewater containing nitrogen (ammonia and nitric acid) is discharged from these processes as a waste liquid.

Biological denitrification treatments are generally employed for removing the nitrogen from wastewaters. These biological denitrification treatments are methods that remove nitrogen by utilizing the nitrate respiration in an oxygen-free environment of denitrifying bacteria which are facultative anaerobic bacteria. In these biological denitrification treatments, for example, the wastewater is first subjected to a nitrification treatment to convert the ammonia nitrogen in the wastewater to nitrite nitrogen or nitrate nitrogen, and a hydrogen donor such as methanol is then added to obtain an oxygen-free state for the denitrification treatment.

The nitrification treatment of the wastewater employs, for example, an activated sludge method, biofilm method (for example, a fixed bed method or a fluidized bed method), or a granule method or the like. Generally, in an activated sludge method, a low-load treatment (for example, 0.1 to 0.3 kg-N/(m³·d) is conducted, whereas in a biofilm method or granule method, a high-load treatment (for example, 0.5 to 1.0 kg-N/(m³·d) is conducted (for example, see Patent Document 1).

Patent Document 2 discloses a technique for adjusting the nitrogen load of a nitrification tank by installing a device for measuring the ammonia nitrogen concentration of the nitrification treated water in the nitrification tank, comparing the measured ammonia nitrogen concentration with a preset ammonia nitrogen concentration (1 to 10 mg/L), and then in those cases where the measured value is less than the preset value, adjusting the nitrogen load so that the measured value exceeds the preset value.

### CITATION LIST

### Patent Literature

Patent Document 1: JP 4865211 B
Patent Document 2: JP H08-126897 A

### SUMMARY

### Technical Problem

An object of the present invention is to provide a water treatment device and a water treatment method which, even if the concentration of a water to be treated containing ammonia nitrogen changes, are capable of producing a treated water of favorable water quality in a stable manner.

### Solution to Problem

A water treatment device according to one aspect of the present invention has a first biological treatment tank for biologically treating with autotrophic bacteria a water to be treated containing ammonia nitrogen, while the water to be treated flows continuously into the first biological treatment tank, a second biological treatment tank for biologically treating with autotrophic bacteria a first treated water that has undergone treatment in the first biological treatment tank, while the first treated water flows continuously into the second biological treatment tank, a bypass line through which a portion of the water to be treated bypasses the first biological treatment tank and flows into the second biological treatment tank, an ammonia nitrogen concentration measurement unit that measures the ammonia nitrogen concentration of a second treated water that has undergone treatment in the second biological treatment tank, and a control device that controls the flow rate of the water to be treated flowing through the bypass line based on the ammonia nitrogen concentration measured by the ammonia nitrogen concentration measurement unit.

In the above water treatment device, the control device preferably controls the flow rate of the water to be treated flowing through the bypass line so that the ammonia nitrogen concentration measured by the ammonia nitrogen concentration measurement unit falls within a preset prescribed range.

In the above water treatment device, the prescribed range is preferably from 0.5 mg/L to 50 mg/L.

The above water treatment device preferably also has a filtration unit for filtering the second treated water, wherein the ammonia nitrogen concentration measurement unit measures the ammonia nitrogen concentration of a filtered water that has been filtered by the filtration unit.

A water treatment method according to one aspect of the present invention has a first biological treatment step of biologically treating a water to be treated containing ammonia nitrogen with autotrophic bacteria in a first biological treatment tank, while the water to be treated flows continuously into the first biological treatment tank, a second biological treatment step of biologically treating, with autotrophic bacteria in a second biological treatment tank, a first treated water that has undergone treatment in the first biological treatment tank, while the first treated water flows continuously into the second biological treatment tank, an inflow step of causing a portion of the water to be treated to bypass the first biological treatment tank and flow into the second biological treatment tank, and an ammonia nitrogen concentration measurement step of measuring the ammonia nitrogen concentration of a second treated water that has undergone treatment in the second biological treatment tank, wherein in the inflow step, the flow rate of the water to be treated bypassing the first biological treatment tank and flowing into the second biological treatment tank is controlled based on the ammonia nitrogen concentration measured in the ammonia nitrogen concentration measurement step.

In the above water treatment method, in the inflow step, the flow rate of the water to be treated bypassing the first biological treatment tank and flowing into the second biological treatment tank is controlled so that the ammonia nitrogen concentration measured in the ammonia nitrogen concentration measurement step falls within a preset prescribed range.

In the above water treatment method, the prescribed range is preferably from 0.5 mg/L to 50 mg/L.

The above water treatment method preferably also has a filtration step of filtering the second treated water, wherein in the ammonia nitrogen concentration measurement step, the ammonia nitrogen concentration of a filtered water that has been filtered in the filtration step is measured.

### Advantageous Effects of Invention

By employing the present invention, a water treatment device and a water treatment method can be provided which, even if the concentration of a water to be treated containing ammonia nitrogen changes, are capable of producing a treated water of favorable water quality in a stable manner.

### BRIEF DESCRIPTION OF DRAWINGS

FIG. 1 is a schematic structural diagram illustrating one example of a water treatment device according to an embodiment of the present invention.

FIG. 2 is a schematic structural diagram illustrating another example of a water treatment tank according to an embodiment of the present invention.

FIG. 3 is a graph illustrating the change over time in the bypass ratio of the water to be treated flowing into the second biological treatment tank relative to the total flow rate of the water to be treated in an example.

FIG. 4 is a graph illustrating the changes over time in the ammonia nitrogen concentration of a second treated water obtained in an example and a comparative example.

### DESCRIPTION OF EMBODIMENTS

Embodiments of the present invention are described below. These embodiments are merely examples of implementing the present invention, and the present invention is not limited to these embodiments.

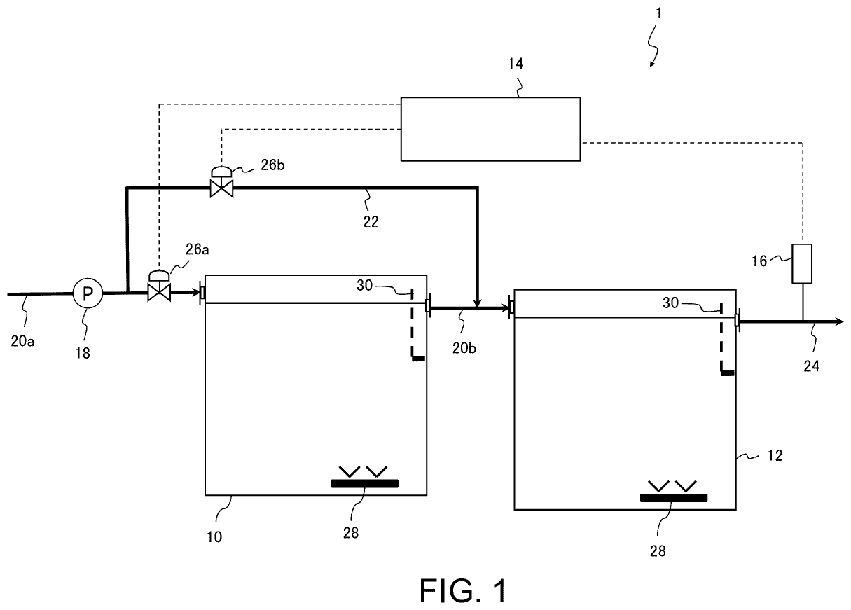

FIG. 1 is a schematic structural diagram illustrating one example of a water treatment device according to an embodiment of the present invention. The water treatment device 1 illustrated in FIG. 1 is a device for conducting a biological treatment of a water to be treated containing ammonia nitrogen using an activated sludge method, a biofilm method or a granule method or the like. The water treatment device 1 illustrated in FIG. 1 contains a first biological treatment tank 10, a second biological treatment tank 12, a control device 14, an ammonia nitrogen concentration meter 16, a pump 18 for the water to be treated, inflow lines (20a and 20b), a bypass line 22, a treated water discharge line 24, and flow rate adjustment valves (26a and 26b). An aerator 28 is installed in the bottom of each of the first biological treatment tank 10 and the second biological treatment tank 12. Further, the a screen 30 that surrounds the treated water outlet is installed in each of the first biological treatment tank 10 and the second biological treatment tank 12.

The inflow line 20a is connected to the inlet of the first biological treatment tank 10. Further, the pump 18 for the water to be treated, and the flow rate adjustment valve 26a are installed in the inflow line 20a. One end of the inflow line 20b is connect to the outlet of the first biological treatment tank 10, and the other end of the inflow line 20b is connected to the inlet of the second biological treatment tank 12. One end of the bypass line 22 is connected to the inflow line 20a, and the other end of the bypass line 22 is connected to the inflow line 20b. Further, the flow rate adjustment valve 26b is installed in the bypass line 22. The treated water discharge line 24 is connected to the outlet of the second biological treatment tank 12. Further, the ammonia nitrogen concentration meter 16 is installed in the treated water discharge line 24.

The control device 14 is connected electrically, via wired or wireless connections, to the ammonia nitrogen concentration meter 16, the pump 18 for the water to be treated, and the flow rate adjustment valves 26a and 26b. Although omitted from the drawing, in those cases where the first biological treatment tank 10 and/or the second biological treatment tank 12 have a pH sensor or a water temperature sensor or the like installed therein, the control device 14 may also be connected to those sensors.

The control device 14 is, for example, composed of a microcomputer comprising a CPU that executes programs and ROM and RAM that store programs and operational results, and electrical circuits and the like, and the control device 14 reads a prescribed program stored in ROM or the like, and executes that program to control the operation of the water treatment device 1. For example, the control device 14 may control the operation of the pump 18 for the water to be treated, and the degrees of opening of the flow rate adjustment valves 26a and 26b.

Next is a description of the operation of the water treatment device 1 according to this embodiment.

The control device 14 operates the pump 18 for the water to be treated and opens the flow rate adjustment valve 26a to a prescribed degree of opening, thereby supplying the water to be treated containing ammonia nitrogen through the inflow line 20a and into the first biological treatment tank 10. At this time, the control device 14 may also open the flow rate adjustment valve 26b to a prescribed degree of opening, thereby causing a portion of the water to be treated passing through the inflow line 20a to bypass through the bypass line 22 and flow into the second biological treatment tank 12 (an inflow step).

Inside the first biological treatment tank 10, an oxygen-containing gas such as air is supplied by the aerator 28, thereby mixing the water to be treated and the autotrophic bacteria. Then, inside the first biological treatment tank 10, the water to be treated is biologically treated under aerobic conditions by the autotrophic bacteria (a first biological treatment step). The ammonia nitrogen within the water to be treated is nitrified by the autotrophic bacteria to form at least one of nitrite nitrogen and nitrate nitrogen. The treated water that has undergone treatment in the first biological treatment tank 10 (a first treated water) passes through the inflow line 20b and flows into the second biological treatment tank 12.

Inside the second biological treatment tank 12, an oxygen-containing gas such as air is supplied by the aerator 28, thereby mixing the first treated water supplied from the inflow line 20b and the water to be treated from the bypass line 22 with the autotrophic bacteria. Then, inside the second biological treatment tank 12, the first treated water and the water to be treated are biologically treated under aerobic conditions by the autotrophic bacteria (a second biological treatment step). The treated water that has undergone treatment in the second biological treatment tank 12 (a second treated water) passes through the treated water discharge line 24 and is discharged outside the system.

Here, the ammonia nitrogen concentration of the second treated water is measured by the ammonia nitrogen concentration meter 16 (an ammonia nitrogen concentration measurement step). Then, the control device 14 controls the flow rate of the water to be treated flowing through the bypass line 22 based on the ammonia nitrogen concentration in the second treated water measured by the ammonia nitrogen concentration meter 16.

### Control Example 1

The ammonia nitrogen concentration of the second treated water flowing through the treated water discharge line 24 is detected by the ammonia nitrogen concentration meter 16, and the detected ammonia nitrogen concentration value is input into the control device 14. In those cases where the input ammonia nitrogen concentration is less than a preset prescribed value, the control device 14 controls the degrees of opening of the flow rate adjustment valves 26a and 26b so as to increase the flow rate of the water to be treated flowing through the bypass line 22. For example, if no water to be treated is flowing into the bypass line 22, then the degrees of opening of the flow rate adjustment valves 26a and 26b are controlled so that the water to be treated flows through the bypass line 22 at a prescribed flow rate. Further, if, for example, some water to be treated is already flowing though the bypass line 22, then the degrees of opening of the flow rate adjustment valves 26a and 26b are controlled so that the water to be treated flows through the bypass line 22 at an increased flow rate that exceeds the existing flow rate by a prescribed proportion. Furthermore, if the input ammonia nitrogen concentration equals or exceeds the preset prescribed value, the control device 14 controls the degrees of opening of the flow rate adjustment valves 26a and 26b so as to reduce the flow rate of the water to be treated flowing through the bypass line 22. For example, the degrees of opening of the flow rate adjustment valves 26a and 26b may be controlled so as to halt inflow of the raw water into the bypass line 22. Alternatively, the degrees of opening of the flow rate adjustment valves 26a and 26b may be controlled so that the water to be treated flows through the bypass line 22 at a lower flow rate that has been reduced from the existing flow rate through the bypass line 22 by a prescribed proportion. In order to ensure stable operation, the preset prescribed value is preferably within a range from 0.6 to 1 times the treatment target value.

Another example of control of the flow rate of the water to be treated is described below.

### Control Example 2

The control device 14 controls the flow rate of the water to be treated flowing through the bypass line 22 so that the ammonia nitrogen concentration falls within a preset prescribed range. For example, upper and lower set values for the ammonia nitrogen concentration are prescribed in advance (set value 1: an upper set value, set value 2: a lower set value). In those cases where the ammonia nitrogen concentration of the second treated water detected by the ammonia nitrogen concentration meter 16 is less than the lower set value (set value 2), the control device 14 controls the degrees of opening of the flow rate adjustment valves 26a and 26b so that the flow rate of the water to be treated flowing through the bypass line 22 increases. Further, in those cases where the ammonia nitrogen concentration of the second treated water measured by the ammonia nitrogen concentration meter 16 is at least as large as the lower set value (set value 2) but less than the upper set value (set value 1), the control device 14 maintains the flow rate of the water to be treated flowing through the bypass line 22. In other words, the degrees of opening of the flow rate adjustment valves 26a and 26b are maintained at their current state. Furthermore, in those cases where the ammonia nitrogen concentration of the second treated water measured by the ammonia nitrogen concentration meter 16 is equal to or greater than the upper set value (set value 1), the control device 14 controls the degrees of opening of the flow rate adjustment valves 26a and 26b so that the flow rate of the water to be treated flowing through the bypass line 22 decreases.

Considering the dischargeable water quality standard of the treated water discharged from the second biological treatment tank 12, the prescribed range (for example, set value 2 to set value 1) is, for example, preferably a range from 0.5 mg/L to 50 mg/L. The set value 2 is preferably set to a value of at least 0.5 mg/L, and is more preferably set within a range from 0.5 mg/L to 5.0 mg/L. The set value 1 is, for example, preferably set to a value of not more than 50 mg/L, and is more preferably set within a range from 1.0 mg/L to 50 mg/L.

The set value 1 may also be set based on the pH value inside the second biological treatment tank 12. For example, a map that defines the relationship between the pH value and the set value (either a relational formula or a table or the like) may be stored in the control device 14. Then, the control device 14 fits the pH value inside the second biological treatment tank 12 measured by a pH meter to the stored map to calculate the set value. The control device 14 sets the calculated value as the above set value 1. By setting the set value 1 based on the pH value, the effect of free ammonia during the nitrification treatment can be suppressed, and the nitrification capability can be improved. For example, in the case of a pH of 7 to 7.5 (water temperature: 20° C.), the set value 1 is preferably set within a range from 1.0 mg/L to 25 mg/L. Further, because the effect of free ammonia is also dependent on the water temperature, the set value 1 is more preferably set based on the pH and the water temperature inside the second biological treatment tank 12.

The flow rate of the water to be treated bypassed into the second biological treatment tank 12 may be changed in accordance with the measurement frequency of the ammonia nitrogen concentration of the second treated water, but the rate of that change is preferably within a range from 0.1 to 20% of the total flow rate of the water to be treated. Further, considering the proliferation rate of the microorganisms such as the nitrifying bacteria, the flow rate of the water to be treated that is bypassed into the second biological treatment tank 12 is preferably increased by no more than 10% per day. By setting the above rate of change to a smaller value when the measurement frequency of the ammonia nitrogen concentration of the second treated water is high, and setting the rate of change to a larger value when the measurement frequency is low, the time period required to achieve the target removal performance can be shortened.

By conducting biological treatment in a two-stage series using a first biological treatment tank and a second biological treatment tank, the first stage can function as a high-load crude treatment, namely a stage in which operations are conducted under conditions of a high ammonia nitrogen concentration inside the tank, and in which the tank is resistant to concentration fluctuations. However, the water to be treated load decreases, and by the time treatment has been completed in the first-stage biological treatment tank, the load on the second-stage biological treatment tank has disappeared, resulting in a reduction in the treatment activity of the second-stage biological treatment tank. Accordingly, it is necessary to ensure that the ammonia nitrogen load in the second-stage biological treatment tank is kept above a certain level, although if the ammonia nitrogen load in the second-stage biological treatment tank becomes too high, then the water quality of the treated water deteriorates. Accordingly, in this embodiment of the present invention, as described above, by controlling the flow rate of the water to be treated that is bypassed into the second-stage biological treatment tank based on the ammonia nitrogen concentration of the treated water that has undergone treatment in the second-stage biological treatment tank, the load in the second-stage biological treatment tank can be stabilized even if the concentration of the water to be treated containing ammonia nitrogen changes, and therefore any reduction in treatment activity due a no-load state, and any deterioration in the treated water quality caused by an excessively high load can be suppressed. In other words, a treated water of favorable water quality can be obtained in a stable manner, even if the concentration of a water to be treated containing ammonia nitrogen changes.

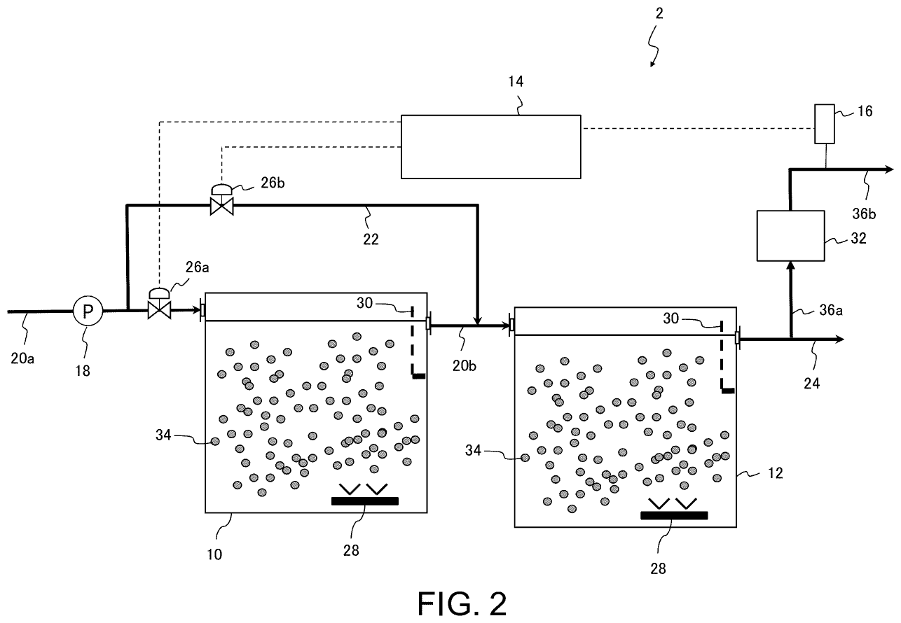

In a water treatment device 2 illustrated in FIG. 2, those components that are the same as in the water treatment device 1 illustrated in FIG. 1 are labeled with the same symbols, and description of those components is omitted here. The water treatment device 2 illustrated in FIG. 2 has a filtration device 32, and a carrier 34 housed inside the first biological treatment tank 10 and the second biological treatment tank 12.

A portion of the second treated water flowing through the treated water discharge line 24 passes through a branch line 36a connected to the treated water discharge line 24, is supplied to the filtration device 32, and undergoes a solid-liquid separation in the filtration device 32. The filtrate obtained in the filtration device 32 is discharged outside the system through a filtrate discharge line 36b. At this time, the ammonia nitrogen concentration in the filtrate flowing through the filtrate discharge line 36b is measured using the ammonia nitrogen concentration meter 16 which is installed in the filtrate discharge line 36b. Then, in the same manner as described above, the flow rate of the water to be treated flowing through the bypass line 22 is controlled based on the measured ammonia nitrogen concentration.

By measuring the ammonia nitrogen concentration of the filtrate that has undergone solid-liquid separation in the filtration device 32, the ammonia nitrogen concentration can be measured with good precision down to low concentration levels. Further, because the filtrate that has undergone solid-liquid separation in the filtration device 32 has had SS components and the like removed, the frequency of maintenance required for the ammonia nitrogen concentration meter 16 can be reduced.

There are no particular limitations on the ammonia nitrogen concentration meter 16, provided the measurements can be conducted on-line, but a coulometric titration ammonia nitrogen meter is preferred. A coulometric titration ammonia nitrogen meter conducts measurements using a coulometric titration method employing coulometry, in principle does not require the creation of a calibration curve, and can use bromine as a titrant, which has high selectivity and reactivity for ammonia. Further, these meters also offer additional advantages, such as an electrode portion that is resistant to soiling, and comparatively easy cleaning using an acid. Accordingly, by using a coulometric titration ammonia nitrogen meter, maintenance requirements can be reduced. The frequency with which measurements are conducted using the ammonia nitrogen concentration meter 16 may be set as appropriate, but conducting one measurement about every 15 minutes is preferred.

The first biological treatment tank 10 and the second biological treatment tank 12 are not restricted to tanks that conduct only nitrification, and may conduct both nitrification and denitrification. Although there are no particular limitations on the configurations of the first biological treatment tank 10 and the second biological treatment tank 12, in terms of supporting as many nitrifying bacteria as possible inside the tank, and not requiring provision of a settling tank, tanks using the biofilm method are preferred. In the biofilm method, for example, the nitrification treatment or the like is conducted by nitrifying bacteria adhered to the carrier 34 and nitrifying bacteria floating within the bulk water.

There are no particular limitations on the carrier 34, and any conventionally known carrier that can be used under aerobic conditions may be used, and examples include plastic carriers, sponge-like carriers, and gel-like carriers, but in terms of achieving a good balance between cost and durability, a sponge-like carrier is preferred.

From the viewpoint of achieving growth and the like of the microorganisms, nutrient salts may be added to the first biological treatment tank 10 and the second biological treatment tank 12. Examples of these nutrient salts include not only the essential nutrients of nitrogen (N) and phosphorus (P), but also trace elements such as sulfur (S), potassium (K), sodium (Na), calcium (Ca), magnesium (Mg), iron (Fe), manganese (Mn), cobalt (Co), nickel (Ni), copper (Cu), zinc (Zn), and molybdenum (Mo).

In terms of achieving growth and the like of the microorganisms, the pH inside the first biological treatment tank 10 and the second biological treatment tank 12 is, for example, preferably set within a range from pH 6 to 8, and in order to better suppress inhibition of free ammonia, is more preferably set within a range from pH 6.8 to 7.2.

The biological treatments in the first biological treatment tank 10 and the second biological treatment tank 12 are preferably conducted under aerobic conditions, and the dissolved oxygen concentration inside the first biological treatment tank 10 and the second biological treatment tank 12 is, for example, typically at least 0.5 mg/L, and preferably 1 mg/L or higher.

The water temperature inside the first biological treatment tank 10 and the second biological treatment tank 12 is, for example, preferably held within a range from 15 to 40° C.

The water to be treated that represents the treatment target may be, for example, an ammonia nitrogen-containing wastewater discharged from a semiconductor production process or the like. In those cases where the water to be treated contains calcium in a concentration of at least 100 mg/L, and preferably a concentration within a range from 100 to 1,000 mg/L, the water treatment method and water treatment device 1 according to embodiments of the present invention can be employed particularly favorably.

### EXAMPLES

The present invention is described below in more specific detail using an example, but the present invention is not limited to the following example.

### Example

Using the water treatment device illustrated in FIG. 2, a continuous water flow test was conducted under the conditions described below. A breeding step was conducted prior to starting the continuous water flow test. Specifically, the water to be treated was first passed only through the first biological treatment tank, once the ammonia nitrogen load had reached 0.6 kgN/(m³·d), two-stage operation using the first biological treatment tank and the second biological treatment tank was started, the breeding step was halted when the total ammonia nitrogen load reached 0.8 kgN/(m³·d), and the continuous water flow test was then conducted. In the following description, the term “biological treatment tank” refers to both the first biological treatment tank and the second biological treatment tank.

### Test Conditions

pH inside biological treatment tank: 7.0 to 7.5 (adjusted using caustic soda)
Biological treatment tank volume: 2 L
Carrier: hydrophobic polyurethane sponge carrier
Carrier fill rate: 30% of biological treatment tank (bulk volume/tank volume)
Water temperature of water to be treated: 20° C.
Ammonia nitrogen concentration in water to be treated: 25, 50 mg/L
Water to be treated composition: ammonium chloride was added to well water in an amount equivalent to the above ammonia nitrogen concentration, and a solution containing sodium carbonate, phosphoric acid and trace elements was then added.
Ammonia nitrogen concentration meter: coulometric titration ammonia nitrogen meter (manufactured by Central Kagaku Corporation)
Water to be treated flow rate: fixed at 64 L/day
Total ammonia nitrogen volume load: 0.4 to 0.8 kgN/(m³·d)
   Total ammonia nitrogen volume load was calculated in the following manner. Total ammonia nitrogen volume load=ammonia nitrogen concentration in water to be treated×water to be treated flow rate÷total tank volume of first biological treatment tank and second biological treatment tank

In the continuous water flow test, operations were conducted for 12 days with the ammonia nitrogen concentration of the water to be treated set to 50 mg/L, the ammonia nitrogen concentration of the water to be treated was then altered to 25 mg/L and operations were conducted for a further 3 days, and the ammonia nitrogen concentration of the water to be treated was then returned to 50 mg/L and operations were continued. The bypass ratio of the water to be treated flowing into the second biological treatment tank relative to the total flow rate of the water to be treated was set to 10% on the first day, and then raised to 20% on day 2, so that some of the water to be treated bypassed the first biological treatment tank and flowed into the second biological treatment tank. From day 3 onward, the ammonia nitrogen concentration of the second treated water was measured every 60 minutes with the ammonia nitrogen concentration meter, and the flow rate of the water to be treated bypassed into the second biological treatment tank was controlled so that the measured concentration fell within a preset ammonia nitrogen concentration range. Specifically, when the ammonia nitrogen concentration of the second treated water was less than 1.0 mg/L, the flow rate of the water to be treated bypassed into the second biological treatment tank was increased, when the ammonia nitrogen concentration of the second treated water was at least 1.0 mg/L but less than 1.5 mg/L, the existing flow rate of the water to be treated bypassed into the second biological treatment tank was maintained, and when the ammonia nitrogen concentration of the second treated water was 1.5 mg/L or higher, the flow rate of the water to be treated bypassed into the second biological treatment tank was reduced.

### Comparative Example

With the exception of conducting no bypass inflow of the water to be treated into the second biological treatment tank, a continuous water flow test was conducted in the same manner as the example.

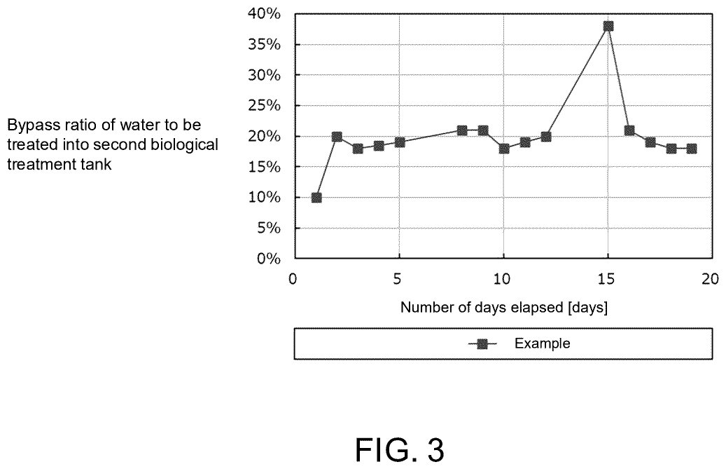

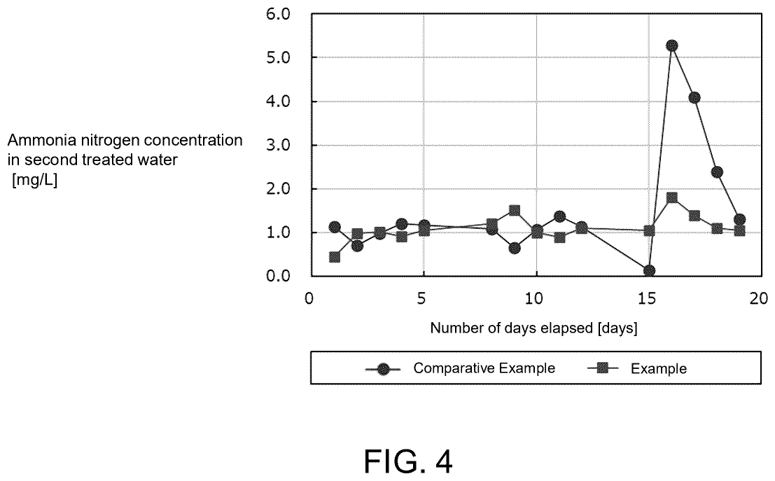

FIG. 3 illustrates the change over time in the bypass ratio of the water to be treated flowing into the second biological treatment tank relative to the total flow rate of the water to be treated in the example. Further, FIG. 4 illustrates the changes over time in the ammonia nitrogen concentration of the second treated water obtained in the example and the comparative example. The values for the bypass ratio of the water to be treated flowing into the second biological treatment tank plotted in FIG. 3 represent average values from 5 measurements conducted per day, and the values for the ammonia nitrogen concentration of the second treated water plotted in FIG. 4 represent average values of all the measured values measured by the ammonia nitrogen concentration meter per day. In the comparative example, as illustrated in FIG. 4, when the ammonia nitrogen concentration of the water to be treated was altered to 25 mg/L, the ammonia nitrogen concentration in the second treated water reached 0.1 mg/L, and extremely favorable water quality was obtained. However, when the ammonia nitrogen concentration of the water to be treated was returned to 50 mg/L, the ammonia nitrogen concentration in the second treated water deteriorated to 5.3 mg/L. Subsequently, 3 days were needed for the ammonia nitrogen concentration in the second treated water to reduce to 2 mg/L (the target water quality). In contrast, in the example, when the ammonia nitrogen concentration of the water to be treated was altered to 25 mg/L, the ammonia nitrogen concentration in the second treated water was 1.1 mg/L, and the bypass ratio for the water to be treated at that time increased from about 20% to 38%. Further, when the ammonia nitrogen concentration of the water to be treated was returned to 50 mg/L, the ammonia nitrogen concentration in the second treated water remained below 2.0 mg/L (the target water quality). Accordingly, as described in the example, in a two-stage treatment using a first biological treatment tank and a second biological treatment tank, by controlling the flow rate of the water to be treated that is bypassed into the second biological treatment tank based on the ammonia nitrogen concentration of the treated water obtained from the second biological treatment tank, a treated water of favorable water quality can be obtained in a stable manner, even if the ammonia nitrogen concentration of the water to be treated changes.

### REFERENCE SIGNS LIST

1,2: Water treatment device
10: First biological treatment tank
12: Second biological treatment tank
14: Control device
16: Ammonia nitrogen concentration meter
18: Pump for water to be treated
20a, 20b: Inflow line
22: Bypass line
24: Treated water discharge line
26a, 26b: Flow rate adjustment valve
28: Aerator
30: Screen
32: Filtration device
34: Carrier
36a: Branch line
36b: Filtrate discharge line

1. A water treatment having:
a first biological treatment tank for biologically treating with autotrophic bacteria a water to be treated containing ammonia nitrogen, while the water to be treated flows continuously into the first biological treatment tank,
a second biological treatment tank for biologically treating with autotrophic bacteria a first treated water that has undergone treatment in the first biological treatment tank, while the first treated water flows continuously into the second biological treatment tank,
a bypass line through which a portion of the water to be treated bypasses the first biological treatment tank and flows into the second biological treatment tank,
an ammonia nitrogen concentration measurement unit that measures an ammonia nitrogen concentration of a second treated water that has undergone treatment in the second biological treatment tank, and
a control device that controls a flow rate of the water to be treated flowing through the bypass line based on the ammonia nitrogen concentration measured by the ammonia nitrogen concentration measurement unit.

2. The water treatment device according to claim 1, wherein the control device controls the flow rate of the water to be treated flowing through the bypass line so that the ammonia nitrogen concentration measured by the ammonia nitrogen concentration measurement unit falls within a preset prescribed range.

3. The water treatment device according to claim 2, wherein the prescribed range is from 0.5 mg/L to 50 mg/L.

4. The water treatment device according to claim 1,
also having a filtration unit for filtering the second treated water, wherein
the ammonia nitrogen concentration measurement unit measures an ammonia nitrogen concentration of a filtered water that has been filtered by the filtration unit.

5. A water treatment method having:
a first biological treatment step of biologically treating a water to be treated containing ammonia nitrogen with autotrophic bacteria in a first biological treatment tank, while the water to be treated flows continuously into the first biological treatment tank,
a second biological treatment step of biologically treating, with autotrophic bacteria in a second biological treatment tank, a first treated water that has undergone treatment in the first biological treatment tank, while the first treated water flows continuously into the second biological treatment tank,
an inflow step of causing a portion of the water to be treated to bypass the first biological treatment tank and flow into the second biological treatment tank, and
an ammonia nitrogen concentration measurement step of measuring an ammonia nitrogen concentration of a second treated water that has undergone treatment in the second biological treatment tank, wherein
in the inflow step, a flow rate of the water to be treated bypassing the first biological treatment tank and flowing into the second biological treatment tank is controlled based on the ammonia nitrogen concentration measured in the ammonia nitrogen concentration measurement step.

6. The water treatment method according to claim 5, wherein in the inflow step, the flow rate of the water to be treated bypassing the first biological treatment tank and flowing into the second biological treatment tank is controlled so that the ammonia nitrogen concentration measured in the ammonia nitrogen concentration measurement step falls within a preset prescribed range.

7. The water treatment method according to claim 6, wherein the prescribed range is from 0.5 mg/L to 50 mg/L.

8. The water treatment method according to claim 5,
also having a filtration step of filtering the second treated water, wherein
in the ammonia nitrogen concentration measurement step, an ammonia nitrogen concentration of a filtered water that has been filtered in the filtration step is measured.
